(19) United States
(12) Patent Application Publication
(10) Pub. No.: US 2006/0139739 A1
(43) Pub. Date: Jun. 29, 2006

(54) Quasi-optical array amplifier

(75) Inventors: J. Aiden Higgins, Westlake Village, CA (US); Avijit Bhunia, Thousand Oaks, CA (US); Karim S. Boutros, Moorpark, CA (US)

Correspondence Address: KOPPEL, PATRICK & HEYBL, 555 ST. CHARLES DRIVE, SUITE 107, THOUSANDS OAKS, CA, 91360, US

(73) Assignee: Rockwell Scientific Licensing, LLC

(21) Appl. No.: 10/956,231

(22) Filed: Nov. 30, 2004

(51) Int. Cl. H01S 3/00

(52) U.S. Cl. 359/333

(57) ABSTRACT

The present invention is an array amplifier designed to alleviate thermal limitations and to provide better power combining efficiency for an array of high power density semiconductor devices. A semiconductor device having an aggregate size required to provide a desired output power is split into many small thermally isolated “unit cells”, each of which is equipped with antennas for input and for output. Power is combined ‘spatially’ off-chip, with each small unit cell operating at a moderate temperature which will not adversely affect performance.

### BACKGROUND OF THE INVENTION

1. Field of the Invention

This invention relates generally to semiconductor devices and, more particularly, to quasi-optical amplifiers which include transistors made from wide bandgap semiconductor material.

2. Description of the Related Art

Some communication systems operate with electromagnetic signals having wavelengths in the millimeter range. The development of millimeter wave systems has been hindered, however, by the immature technology of components such as power amplifiers. The performance of a power amplifier is typically indicated by its ability to provide a desired output power at a given frequency.

One approach to improving the performance of an output amplifier having an output power which is too low is to use multiple smaller amplifiers that are coupled together such that their output powers add. Such coupling is usually accomplished by means of a corporate power combining tree network. However, when the number of smaller amplifiers needed to provide a desired high output power is large, the resulting tree network may have many levels, and losses due to the tree combining network may become unacceptable.

Thermal problems can also arise when using high power amplifiers, especially when the amplifiers are made from transistors having high power densities. Such devices are typically made from wide bandgap semiconductor materials such as gallium nitride (GaN) designed for operation at very high frequencies. As the frequency of an input signal increases, the size of the amplifying transistors should decrease so that they have smaller capacitances and therefore maintain gain. This results in a corresponding reduction in the amplifier output power, so that more amplifier devices are required to achieve the necessary power level. For instance, assume that one large device operating at 10 GHz can typically provide 1000 milliwatts (mW) of output power, but a smaller device operating at 100 GHz can only provide 10 milliwatts of power. Thus, at least 100 smaller devices would be needed in an array to provide 1000 mW of power at 100 GHz. Hence, to obtain power levels on the order of watts at higher frequencies, hundreds of amplifiers would need to be combined. In an orthodox corporate tree network approach to power combining at 30 GHz or higher, the many small amplifiers must be tightly clustered to maintain phase coherence.

This presents problems because the operating temperature increases with the tight clustering of many small transistors, particularly when the transistors have a high power density. At higher temperatures, the transistors are not as efficient, so their gains begin to decrease. As the number of transistors increases, a point is reached where the loss from temperature effects will exceed the gain produced by the transistors. As a result, adding more devices only further reduces the gain and output power, instead of increasing it.

One approach to reducing such losses is the use of a quasi-optical array amplifier. These are discussed, e.g., in U.S. Pat. No. 5,392,152 and in “A 44-GHz Monolithic Waveguide Plane-Wave Amplifier with Improved Unit Cell Design,” by Kwon et al., IEEE Transactions on Microwave Theory and Techniques, Vol. 46, No. 9, September 1998. Instead of using one large amplifying device, a quasi-optical array amplifier comprises a number of unit cells, each of which comprises one or more transistors. Overall output power is provided by wirelessly combining the outputs of all unit cells, using input and output antennas at each cell. This is referred to as ‘Spatial Power Combining’.

### SUMMARY OF THE INVENTION

The present invention provides a quasi-optical array amplifier which overcomes the problems noted above, providing a means of combining the outputs of numerous high power density transistors with low losses, while also reducing temperature-related performance degradation.

The present amplifier is designed to alleviate thermal limitations and to provide better power combining efficiency for an array of high power density semiconductor devices. A semiconductor device having an aggregate size required to provide a desired output power is split up into many small thermally isolated “unit cells”, each of which is equipped with antennas for input and for output. Power is combined ‘spatially’ off-chip, with each small unit cell operating at a moderate temperature which will not adversely affect performance. The present solution is particularly appropriate for use with amplifiers which need to provide high power at frequencies greater than 30 GHz, that employ very high power density wide bandgap semiconductors.

Each unit cell comprises at least one high power density transistor having a current circuit and a control input and arranged to conduct an output current in response to an input signal applied to its control input. An input antenna is coupled to and applies an input signal to each transistor's control input, and an output antenna is coupled to its current circuit and provides an output signal.

The unit cells are distributed on the substrate such that each is thermally isolated from every other unit cell. The array amplifier is also arranged such that RF signals propagate through the plane of the array via the input and output antennas and are combined spatially to produce an overall amplifier output. The use of the input and output antennas greatly improves the amplifier's power combining efficiency, and the thermally isolated unit cells avoid temperature related problems that might otherwise arise.

These and other features, aspects, and advantages of the present invention will become better understood with reference to the following drawings, description, and claims.

### BRIEF DESCRIPTION OF THE DRAWINGS

FIG. 1 is a diagram of a quasi-optical array amplifier which illustrates the principles of the present invention.

FIG. 2 is a schematic diagram of a unit cell within an array amplifier per the present invention.

FIG. 3a is a more-detailed diagram of a quasi-optical array amplifier per the present invention.

FIG. 3b is another possible embodiment of the present array amplifier, preferred for higher signal gain

FIG. 4 is a graph showing the junction temperature (° C.) verses the RF power (W) of an array amplifier per the present invention.

FIG. 5 is a graph of the normalized power verses the number of unit cells in an array amplifier per the present invention.

FIG. 6 is a simplified perspective views of a special Electromagnetic Crystal (EMXT) waveguide with an array amplifier per the present invention.

FIG. 7 is a cut-away sectional view of an amplifier section included in the waveguide of FIG. 6.

### DETAILED DESCRIPTION OF THE INVENTION

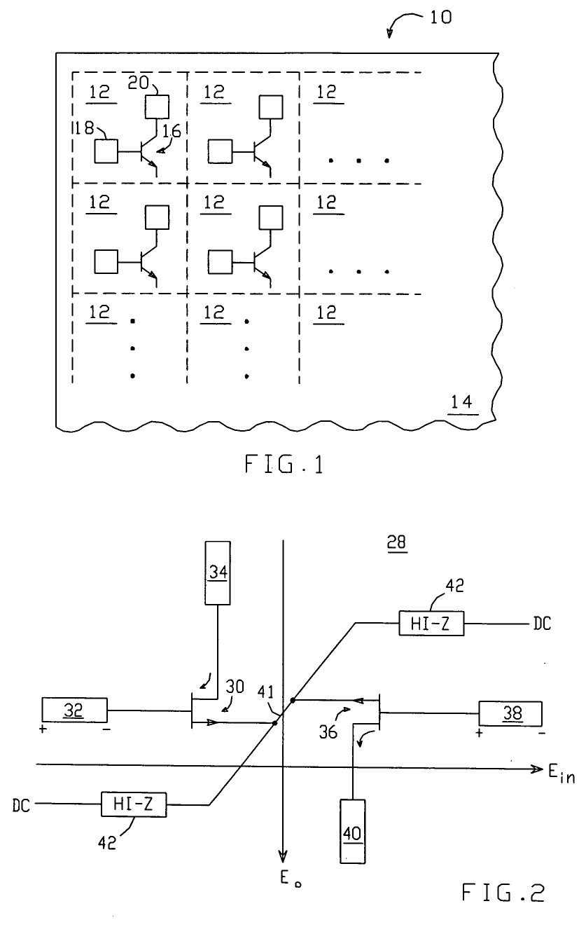

The present invention provides a means of overcoming thermal and power combining difficulties for amplifiers in an array amplifier made from a plurality of high power density transistors. The basic principles of the invention are illustrated in FIG. 1. A quasi-optical array amplifier 10 is comprised of a plurality of “unit cells” 12. Each unit cell contains at least one transistor having a high power density. Such transistors are typically made from wide bandgap semiconductor materials; examples include GaN, aluminum gallium nitride (AlGaN), silicon carbide (SiC) and indium gallium nitride (InGaN). The choice of wide bandgap material depends on the desired bandgap energy and power density, among other parameters. Because of its larger bandgap energy, amplifiers based on a wide bandgap material can provide much greater power density than those based on other material systems, such as gallium arsenide (GaAs).

The unit cells are distributed on a substrate 14, typically in a uniform manner. As noted above, each unit cell comprises at least one high power density transistor 16, which may be a field-effect transistor (FET), or a bipolar transistor (BJT) as shown in FIG. 1. Each transistor has a current circuit (drain-source if a FET, collector-emitter if bipolar) and a control input (gate if FET, base if bipolar), and is arranged to conduct an output current in response to an input signal applied to its control input.

An input signal is applied to the base of transistor 16 (assuming a BJT) via an input antenna 18 coupled to the base. An output antenna 20 is coupled to the collector of transistor 16 and provides the unit cell's output signal. The use of input and output antennas as described herein enables RF signals to propagate through the plane of the array and to be combined spatially to produce an overall output, with the input antennas receiving input power and the output antennas re-transmitting amplified power. In this way, unit cells 12 are coupled together so that they operate as a single amplifier in which their individual output powers add to provide a high power output, with power passing through the plane of the array, rather than along that plane. Thus, power combining losses that might otherwise be incurred by the use of, for example, a corporate tree, are greatly reduced.

To avoid thermal problems that might otherwise arise, particularly due to the use of high power density transistors, unit cells 12 are small and are distributed across substrate 14 such that each is thermally isolated from every other unit cell. That is, the unit cells are separated from each other by a distance sufficient to ensure that the temperature of one unit cell is not affected by or increased by the dissipated power of neighboring unit cells. Proper thermal management is achieved when heat generated by the unit cell transistors is efficiently transferred to the surrounding environment and away from array 10 so as to keep the array at or below a desired operating temperature.

Thus, when high power density transistors are employed in a quasi-optical array amplifier as described herein, power combining losses and thermal problems that might otherwise arise with prior art configurations are mitigated.

There are many different types of transistors that could be included in unit cells 12, such as wide bandgap high electron mobility transistors or metal-semiconductor FETs. The choice of transistor structure and its corresponding material typically depends on the requirements of a particular application, which establishes the frequency, gain, and output power needed. Unit cells 12 can also include p-type transistors, though for simplicity and ease of discussion, only n-type devices are shown herein.

Substrate 14 can include aluminum nitride (AlN), gallium nitride (GaN), silicon carbide (SiC), or another material which provides a desired thermal conductance to convey the dissipated heat away from unit cells 12.

A more detailed schematic diagram of a unit cell 28 as might be used in the present array amplifier is shown in FIG. 2. Here, the unit cell's high power density transistors are shown as FETs. A first FET 30 has its gate connected to an input antenna 32 and its drain connected to an output antenna 34. A second FET 36 has its gate connected to an input antenna 38 and its drain connected to an output antenna 40. The sources of FETs 30 and 36 are preferably connected together at a common source node 41, which is in turn connected to one or more high-impedance elements 42, which are in turn coupled to a DC supply voltage; the basic cell 28 is a balanced push-pull amplifier cell with the source node acting as a virtual AC ground. Connections necessary to provide DC bias voltages to FETs 30 and 36 are not shown.

FETs 30 and 36 are connected in a balanced push-pull configuration as shown in FIG. 2. In the presence of an input signal E-field Eᵢₙ, voltages are developed across input antennas 32 and 38 as shown, which causes the current conducted by one FET (30, when Eᵢₙ is as shown) to increase, and the current conducted by the other FET (36) to decrease by an equal amount. This configuration enables the operation of the two FETs to be balanced, and results in an AC current of zero at common source node 41. The resulting output E-field Eₒᵤₜ is as shown.

Note that it is not essential that each unit cell contain two transistors. The invention is also applicable to unit cells having one transistor, or unit cells having more than two transistors. For example, additional gain can be achieved by providing two pairs of transistors in each unit cell, with each pair connected in a cascode arrangement.

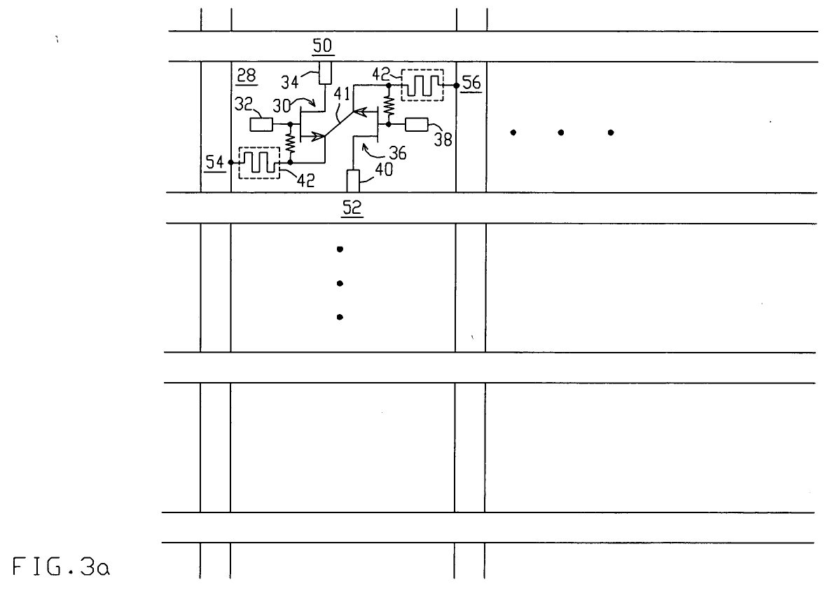

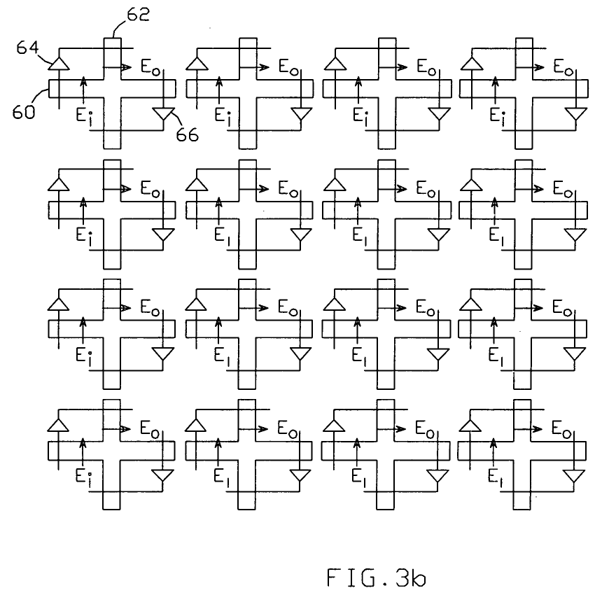

A more detailed diagram of an array amplifier per the present invention is shown in FIG. 3a, which illustrates how DC bias voltages might be provided to the unit cell transistors. As in FIG. 2, unit cell 28 comprises FETs 30 and 36 connected in a balanced push-pull configuration, with their gates connected to input antennas 32 and 38 and their drains connected to output antennas 34 and 40. Here, output antennas 34 and 40 contact DC busbars 50 and 52, respectively, which provide DC bias voltages to the FETs' drain terminals. Similarly, high impedance elements 42 are connected to DC busbars 54 and 56, respectively. Then, the gate terminals of FETs 30 and 36 are coupled to their respective source terminals, and are thereby biased by the DC voltage on busbars 54 and 56. When configured as shown, the DC voltage on busbars 50 and 52 would typically be a positive voltage, with the DC voltage on busbars 54 and 56 being a negative voltage; the DC voltages are selected to provide appropriate DC operating points for the unit cell transistors. In this way, RF pathways through the array amplifier are provided by the input and output antennas, while DC pathways are provided by busbars.

FIG. 3b presents an alternate form of the array amplifier. In this form, the input and output antennas 60,62 take the form of crossed slot antennas in the ground plane of a microstrip substrate. The input antenna is decoupled from the output antenna by being of orthogonal polarization. The many small amplifiers 64,66 are arranged in pairs around each cross as illustrated in FIG. 3b. Being on microstrip, these small amplifiers can be unbalanced and may have multiple stages to provide high levels of gain. The pairs of these amplifiers connected as shown are driven in push-pull by the input antenna, and drive the output antenna in push-pull.

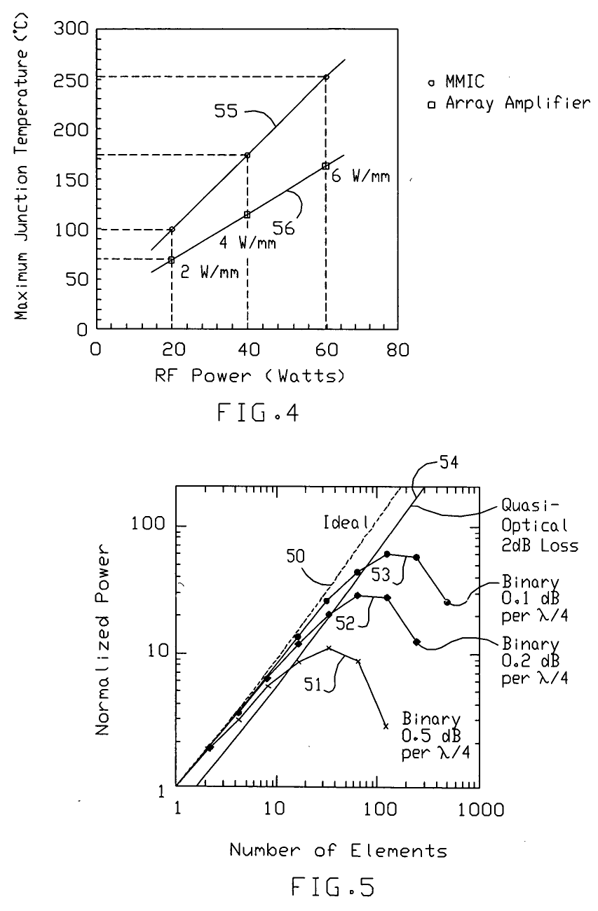

FIG. 4 is a graph of the maximum junction temperature (° C.) verses the power (W) of an array amplifier per the present invention (curve 56). Also shown in FIG. 4 for comparison purposes are the results from a typical monolithic microwave (MMIC) corporate power combining tree network (curve 55). As indicated in FIG. 4, the junction temperature for the array amplifier is less then that for a typical MMIC.

FIG. 5 is a graph of normalized power curves verses number of unit cell elements for various amplifier configurations. The normalized power corresponds to the power of signal Eₒᵤₜ divided by the power of signal Eᵢₙ. Also plotted for comparison is a curve 50 corresponding to the ideal value. Curve 50 has a linear slope, which means that the normalized power is directly proportional to the number of elements in the array. Curves 51, 52, and 53 are for arrays using a corporate feed-type power combining network assuming power losses per branch of 0.5 dB, 0.2 dB, and 0.1 dB, respectively; curve 54 is for array amplifier in accordance with the present invention. In curve 51, normalized power starts to decrease as the number of elements increases past about thirty, while for curves 52 and 53, the decrease starts at around ninety and one hundred elements, respectively. For a small number of elements, normalized power increases linearly, but then starts to decrease as the number of elements increases past a point where the heat generated starts to degrade the performance of the array. The heat generated increases with the power loss per branch.

However, for an array amplifier in accordance with the present invention (and assuming a 2 dB total loss), normalized power increases linearly for an array with greater than one hundred elements and a normalized power greater than one hundred. This indicates that the heat dissipation properties of an array per the present invention are significantly improved so that the normalized power does not significantly degrade as the number of elements and, consequently, the heat and output power, increases.

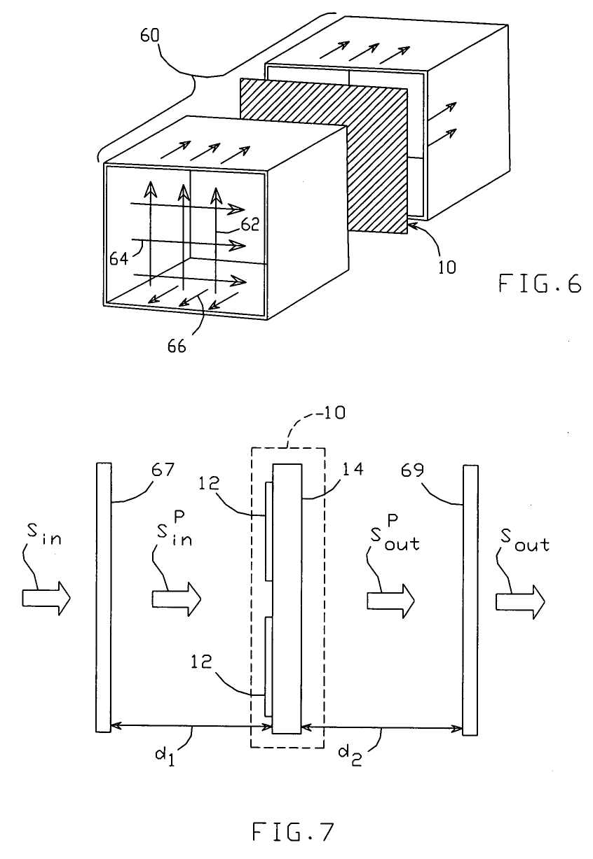

In practice, the present array amplifier would typically be packaged within a waveguide, which should be capable of supporting two orthogonally polarized TEM waves. A preferred waveguide is an electromagnetic crystal waveguide (“EMXT guide”), which is described, for example, in U.S. Pat. No. 6,603,357. FIG. 6 is a simplified perspective view of an electromagnetic crystal waveguide 60 which includes an array amplifier 10 per the present invention. E-field 62, H-field 64 and current 66 are oriented as shown. The waveguide's sidewalls present a high impedance surface for the TEM E-field 62, and a short-circuit for a longitudinal tangential E-field.

FIG. 7 is a cut-away sectional view of the array amplifier and waveguide shown in FIG. 6, which includes an input polarizer 67 and an output polarizer 69. In operation, input signal Sᵢₙ enters the waveguide and is guided such that it is incident to polarizer 67, which is transparent for the input polarization. This polarized signal, denoted as Sᵢₙ^{P}, is incident to array 10 which amplifies it to provide an orthogonally polarized output signal Sₒᵤₜ^{P}. Signal Sₒᵤₜ^{P} is incident to polarizer 69, which is transparent for the output polarization and provides output signal Sₒᵤₜ. In one example, signal Sᵢₙ^{P} can have a horizontally polarized electric field and signal Sₒᵤₜ^{P} can have vertically polarized electric field.

Polarizer 69 is preferably spaced a distance d₂ from array amplifier 10 to provide a desired input return loss, and polarizer 67 is spaced a distance d₁ from amplifier 10 to provide maximum signal Sₒᵤₜ with a desired output power. Hence, the distance of the polarizers from amplifier 10 can be adjusted, allowing the polarizers to function as input and output tuners for array 10.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A quasi-optical array amplifier, comprising:
a substrate; and
an array of unit cells on said substrate, each of said cells comprising:
at least one transistor having a current circuit and a control input and arranged to conduct an output current in response to an input signal applied to said control input, said transistor characterized as having a high power density;
an input antenna coupled to and applying an input signal to said transistor's control input; and
an output antenna coupled to said current circuit and providing an output signal;
said unit cells separated from each other on said substrate by a distance sufficient to ensure that the temperature of one unit cell is not affected by or increased by the dissipated power of neighboring unit cells, such that each unit cell is thermally isolated from every other unit cell;
said array amplifier arranged such that RF signals propagate through the plane of said array via said input and output antennas and are combined spatially to produce an overall amplifier output.

2. The amplifier of claim 1, wherein said at least one transistor comprises first and second transistors connected in a balanced push-pull configuration and having respective input and output antennas.

3. The amplifier of claim 2, wherein said first and second transistors are field-effect transistors (FETs), said FETs' gates connected to respective input antennas, their drains connected to respective output antennas, and their sources connected to a DC voltage via a high impedance element.

4. The amplifier of claim 3, wherein said FETs' drains are coupled to and biased by a busbar carrying a DC voltage, and said FETs' gates are coupled to and biased by the DC voltage on their source terminals.

5. The amplifier of claim 2, wherein said first and second transistors are bipolar transistors (BJTs), said BJTs' bases connected to respective input antennas, their collectors connected to respective output antennas, and their emitters connected to a DC voltage via a high impedance element.

6. The amplifier of claim 3, wherein said BJTs' collectors are coupled to and biased by a busbar carrying a DC voltage, and said BJTs' bases are coupled to and biased by the DC voltage on their emitter terminals.

7. The amplifier of claim 1, wherein said transistor comprises a wide bandgap semiconductor material.

8. The amplifier of claim 7, wherein said transistor comprises gallium nitride (GaN).

9. The amplifier of claim 7, wherein said transistor comprises silicon carbide (SiC).

10. The amplifier of claim 1, wherein said substrate has a thermal conductance necessary to convey dissipated heat away from said unit cells such that each unit cell is thermally isolated from every other unit cell.

11. The amplifier of claim 10, wherein said substrate is gallium nitride (GaN).

12. The amplifier of claim 1, wherein said substrate is a microstrip substrate, said input and output antennas take the form of crossed slot antennas in the ground plane of said microstrip substrate, and said input antennas are decoupled from said output antennas by being of orthogonal polarization.

13. The amplifier of claim 12, wherein said at least one transistor comprises first and second transistors connected in a push-pull configuration.

14. The amplifier of claim 12, wherein said at least one transistor comprises first and second amplifiers each of which is connected between respective input and output antennas.

15. The amplifier of claim 14, wherein said first and second amplifiers are unbalanced.

16. The amplifier of claim 14, wherein said first and second amplifiers have multiple stages to provide high levels of gain.

17. A quasi-optical array amplifier, comprising:
a substrate; and
an array of unit cells on said substrate, each of said cells comprising:
first and second transistors made from a wide bandgap semiconductor material, each having a current circuit and a control input and arranged to conduct an output current in response to an input signal applied to said control input, said pair of transistors connected in a balanced push-pull configuration;
first and second input antennas coupled to and applying respective input signals to the control inputs of said first and second transistors; and
first and second output antennas coupled to the current circuits of said first and second transistors, respectively, and providing respective output signals;
said unit cells separated from each other on said substrate by a distance sufficient to ensure that the temperature of one unit cell is not affected by or increased by the dissipated power of neighboring unit cells, such that each unit cell is thermally isolated from every other unit cell;
said substrate having a thermal conductance sufficient to convey dissipated heat away from said unit cells such that each unit cell is thermally isolated from every other unit cell;
said array amplifier arranged such that RF signals propagate through the plane of said array via said input and output antennas and are combined spatially to produce an overall amplifier output.

18. The amplifier of claim 17, wherein said first and second transistors each comprise at least two transistors connected in a cascode arrangement.

19. The amplifier of claim 17, wherein said substrate is a microstrip substrate, said input and output antennas take the form of crossed slot antennas in the ground plane of said microstrip substrate, and said input antennas are decoupled from said output antennas by being of orthogonal polarization.

20. A communication system, comprising:
a waveguide; and
a quasi-optical array amplifier positioned within said waveguide, said amplifier, comprising:
a substrate; and
an array of unit cells on said substrate, each of said cells comprising:
at least one transistor having a current circuit and a control input and arranged to conduct an output current in response to an input signal applied to said control input, said transistor characterized as having a high power density;
an input antenna coupled to and applying an input signal to said transistor's control input; and
an output antenna coupled to said current circuit and providing an output signal;
said unit cells separated from each other on said substrate by a distance sufficient to ensure that the temperature of one unit cell is not affected by or increased by the dissipated power of neighboring unit cells, such that each unit cell is thermally isolated from every other unit cell;
said array amplifier arranged such that RF signals propagate through the plane of said array via said input and output antennas and are combined spatially to produce an overall amplifier output.

21. The system of claim 20, wherein said waveguide is an electromagnetic crystal waveguide.
